(19) United States
(12) Patent Application Publication
(10) Pub. No.: US 2024/0195109 A1
(43) Pub. Date: Jun. 13, 2024

(54) HIGH SPEED ELECTRICAL CONNECTOR AND METHOD OF MANUFACTURING SAME

(71) Applicants: APTIV CONNECTION SYSTEMS (NANTONG) LTD., Jiangsu (CN); APTIV ELECTRICAL CENTERS (SHANGHAI) CO. LTD., Shanghai (CN)

(72) Inventors: Mei YE, Shanghai (CN); Haifei GUAN, Shanghai (CN)

(21) Appl. No.: 18/533,411

(22) Filed: Dec. 8, 2023

(30) Foreign Application Priority Data
Dec. 8, 2022 (CN) 202211570996.0

(51) Int. Cl. H01R 13/50; H01R 13/405; H01R 13/6581; H01R 43/18; H01R 43/24

(52) U.S. Cl. CPC H01R 13/50; H01R 13/405; H01R 13/6581; H01R 43/18; H01R 43/24; H01R 2201/26

(57) ABSTRACT

An electrical connector includes a terminal assembly consisting of a terminal module and a shielding housing, the terminal module contains a conductive terminal and an insulator. The insulator is molded on the conductive terminal and wraps around the conductive terminal. The shielding housing defines an accommodating cavity. The terminal module is removably secured within the accommodating cavity. The electrical connector also includes a plastic housing. The plastic housing defines a matching channel. The shielding housing is removably secured within the matching channel. The material forming the insulator is different that the material forming the plastic housing.

### CROSS-REFERENCE TO RELATED APPLICATION

This application claims benefit of priority to Chinese Patent Application No. 202211570996.0 filed on Dec. 8, 2022, the entire disclosure of which is hereby incorporated by reference.

### TECHNICAL FIELD OF THE INVENTION

The disclosure relates to electrical connectors, and in particular to a high-speed electrical connector.

### BACKGROUND

An electrical connector is a conductor device for connecting electrical wiring. Such a component may serve as an end point for connecting between different elements in a same circuit system or may serve to provide electrical and data connections between different circuit systems and equipment. It is widely used in a variety of electrical wirings, playing the role of connecting or disconnecting the circuits. Such connections may be temporary and easy to plug and unplug at any time or may be permanent junctions between electrical equipment or cables.

In existing high-speed electrical connectors (e.g., existing high-speed single-channel Ethernet board-end electrical connectors), terminal insulators are typically designed to be integral with the jacket for the board-end electrical connector. For example, FIG. 1A and FIG. 1B show a front view and left view of an existing H-MTD Ethernet connector 1. As shown in FIGS. 1A and 1B, the Ethernet connector 1 may comprise a conductive terminal 2 and a plastic housing 3. The conductive terminal 2 is inserted directly into and penetrates the plastic housing 3. The plastic housing 3 is integrally formed. A portion of the plastic housing 3 that surrounds the conductive terminal 2 is used to provide insulation between conductive terminals 2 and between the conductive terminal 2 and the shielding housing 4.

However, for increasingly demanding in-vehicle applications, relative permittivity of commonly used original materials cannot meet the requirements for a transmission rate of 10 gigabits per second (Gbps), and special relative permittivity materials meeting the high-speed requirements are often expensive, resulting in high material costs for integrally designed products. For the structures shown in FIGS. 1A and 1B, if it is required to replace the material of the entire plastic housing 3 with intended material with better high frequency performance, such as LCP (Liquid Crystal Polymer), it will typically lead to a significant increase in cost.

### SUMMARY

A high-speed electrical connector and a method for manufacturing the same are provided herein. The high-speed electrical connector provides high reliability while reducing or controlling the manufacturing cost of the high-speed electrical connector.

In some aspects, the techniques described herein relate to an electrical connector, including: a terminal assembly consisting of a terminal module and a shielding housing, the terminal module including at least one conductive terminal and at least one insulator, wherein the at least one insulator is molded on the at least one conductive terminal and wraps around the at least one conductive terminal, wherein the shielding housing defines an accommodating cavity, wherein the terminal module is removably secured within the accommodating cavity; and a plastic housing defining a matching channel, wherein the shielding housing is removably secured within the matching channel and wherein a first material of the at least one insulator is different from a second material of the plastic housing.

In some aspects, the techniques described herein relate to a method for manufacturing an electrical connector, including: forming at least one insulator on at least one conductive terminal through a molding process, wherein the at least one insulator wraps around the at least one conductive terminal: assembling the at least one insulator along with the at least one conductive terminal into an accommodating cavity of a shielding housing to form a terminal assembly: and assembling the shielding housing along with the at least one insulator as well as the at least one conductive terminal into a matching channel of a plastic housing, wherein a first material of the at least one insulator is different from a second material of the plastic housing.

### BRIEF DESCRIPTION OF THE DRAWINGS

The present invention is now described, by way of example with reference to the accompanying drawings, in which:

FIG. 1A is a front view showing an Ethernet connector of the prior art.

FIG. 1B is a left view showing an Ethernet connector of the prior art.

FIG. 2 is an isometric view showing a high-speed electrical connector according to an embodiment of the disclosure.

FIG. 3 is an exploded view showing a high-speed electrical connector according to an embodiment of the disclosure.

FIG. 4 is an exploded view showing, as viewed from the direction of arrow II in FIG. 3, the high-speed electrical connector according to the embodiment of the disclosure.

FIG. 5 is a front view showing the high-speed electrical connector as viewed from the direction of arrow I in FIG. 2 according to the embodiment of the disclosure.

FIG. 6 is a cross-sectional view showing the high-speed electrical connector as cut along line A-A shown in FIG. 5 according to the embodiment of the disclosure.

FIG. 7 is a flowchart showing a method of manufacturing a high-speed electrical connector according to an embodiment of the disclosure.

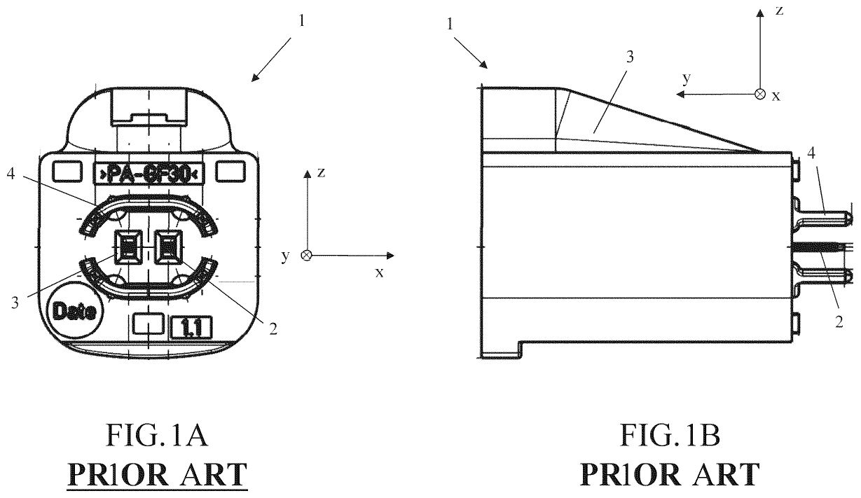

### DETAILED DESCRIPTION

The following is description with respect to specific embodiments, and other advantages and technical effects of the disclosure may be clearly understood by those skilled in the art from the contents disclosed herein. Moreover, the disclosure is not limited to the following specific embodiments but may be implemented or applied by other different embodiments, and various modifications and changes may be made to the specific contents of the present description without departing from the spirit of the disclosure.

In the following, specific embodiments of the disclosure are described in detail based on the accompanying drawings. It is to be appreciated that, the drawings are illustrated for a brief explanation only, and such drawings are not depicted on the actual dimension, not reflecting actual dimensions of the relevant structures. For ease of understanding, like reference numerals are used in the drawings to indicate like elements across the drawings. The drawings are not to scale and may be simplified for clarity. Elements and features of one embodiment may be advantageously incorporated into other embodiments without further recitation.

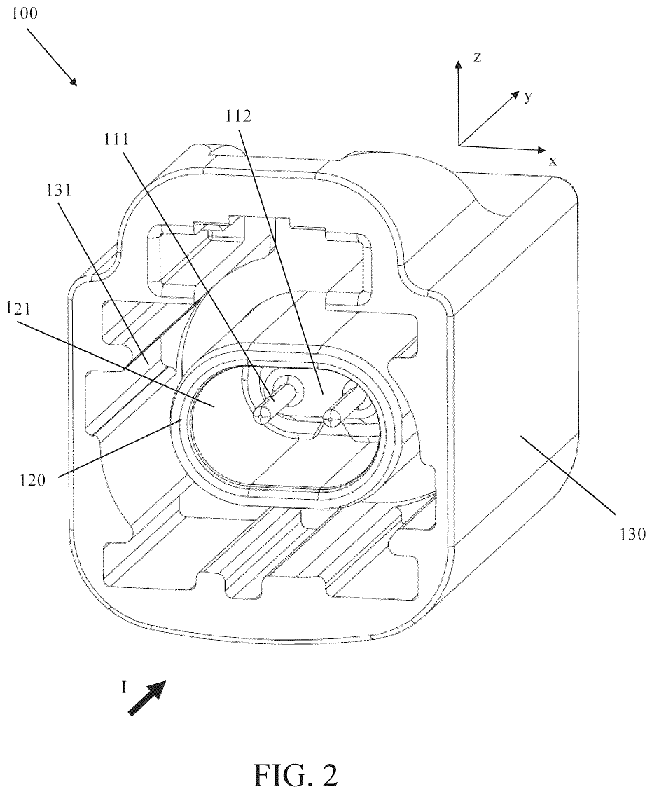

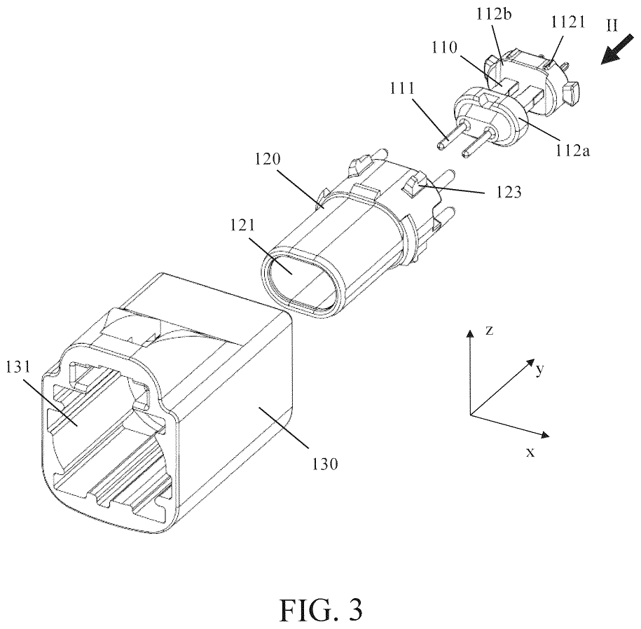

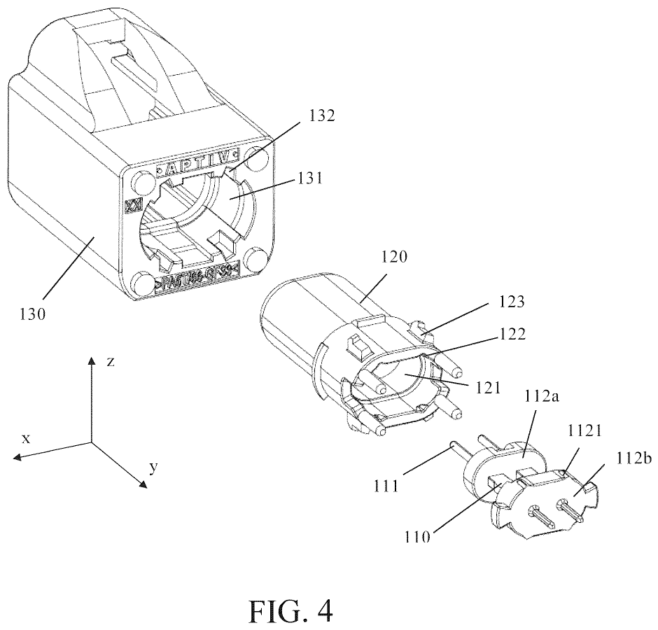

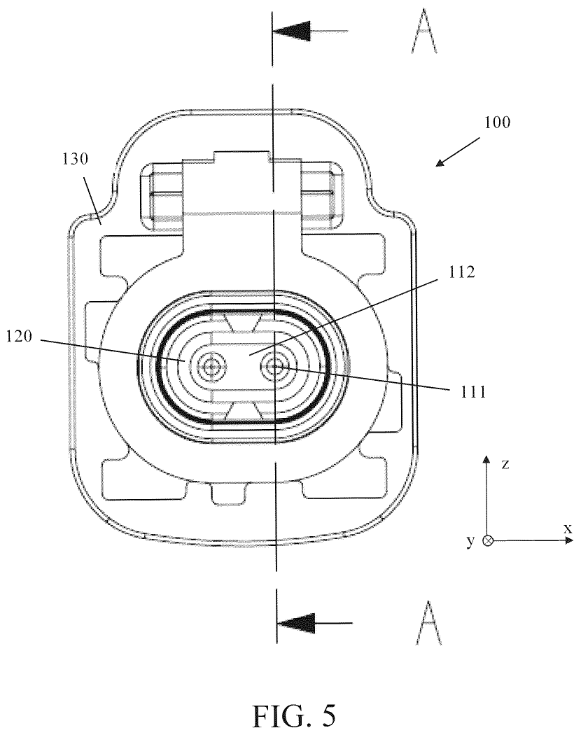

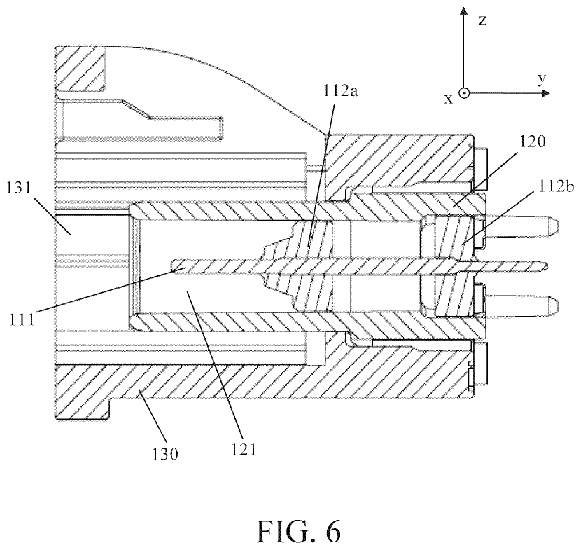

In the following, a high-speed electrical connector 100 according to an embodiment of the disclosure is described with respect to FIGS. 2-6. FIG. 2 shows an isometric view of a high-speed electrical connector 100, FIG. 3 shows an exploded view of the high-speed electrical connector 100, FIG. 4 shows a an exploded view of the high-speed electrical connector 100 as viewed from the direction of arrow II in FIG. 3, FIG. 5 shows a front view of the high-speed electrical connector 100 as viewed from the direction of arrow I in FIG. 2, and FIG. 6 is a cross-sectional view as cut along line A-A shown in FIG. 5.

As shown in FIGS. 2-6, the high-speed electrical connector 100 may comprises a terminal module 110, a shielding housing 120, and a plastic housing 130.

The terminal module 110 may comprise at least one conductive terminal 111 and at least one insulator 112. The insulator 112 may be molded on the conductive terminal 111 and wrapping around the conductive terminal 111. The term “wrapping” as used herein is intended to indicate tightly enveloping so that substantially no gap or only a very small gap existing therebetween. As a non-limiting example, the insulator 112 may be molded on the conductive terminal 111 and wrapping the conductive terminal 111 by insert molding. However, the disclosure is not so limited, and the insulator 112 may be formed or molded on a portion of the conductive terminal 111 or the entire conductive terminal 111 by a variety of other molding methods including, but not limited to, immersion molding, spray molding, deposition molding, and among others. The insulator 112 may be made of various insulating materials. As an example, the insulator 112 may be made of an insulating material with an intended relative permittivity capable of meeting the requirements of a data transmission rate of 10 gigabits per second (Gbps) or more. LCP (Liquid Crystal Polymer) or the like for example.

As a non-limiting example, some or all of the conductive terminal 111 of the terminal module 110 may be a signal terminal for transmitting data signal. For example, the conductive terminal 111 may be a signal terminal adapted for High Speed-Modular Twisted-pair Data (H-MTD) connectors. High Speed Data (HSD) connectors, High-Speed FAKRA-Mini (HFM) connectors, Modular Twisted-pair Data (MTD) connectors, and so on. Examples with two conductive terminals 111 are depicted in FIGS. 2-6, but not so limited, and any number of conductive terminals 111 may be provided.

As a non-limiting example, referring to FIGS. 3, 4 and 6, insulators 112 may comprise a first insulator 112a and a second insulator 112b. The first insulator 112a may be positioned in the middle of the conductive terminal 111. The second insulator 112b may be positioned near the end of the conductive terminal 111.

The shielding housing 120 may define an accommodating cavity 121. The terminal module 110 may be removably secured within the accommodating cavity 121. The shielding housing 120 may be made of any suitable material, for example metallic materials, so as to be able to provide adequate electromagnetic shielding to the conductive terminals 111 mounted therein when the terminal module 110 is secured in place within the accommodating cavity 121.

A terminal module 110 and a shielding housing 120, after being assembled together, form an assembly which is to be referred to as “terminal assembly” throughout this application.

As a non-limiting example, a first mating structure 1121 may be formed on the insulator 112, and a second mating structure 122 for mating with the first mating structure 1121 may be formed on the inner wall of the shield housing 120. With the mating of the first mating structure 1121 to the second mating structure 122, the terminal module 110 may be removably secured in place within the accommodating cavity 121 in a fixed orientation.

As a non-limiting example, it is shown in FIGS. 3 and 4 that the first mating structure 1121 may be a tab and the second mating structure 122 may be a groove, both of which may be secured to each other by an interference fit. However, without limitation, the first mating structure 1121 and the second mating structure 122 may be mating structures of any type, for example, the first mating structure 1121 may be a groove and the second mating structure 122 may be a tab or a beam, the first mating structure 1121 may be a pin and the second mating structure 122 may be a socket, the first mating structure 1121 may be a groove and the second mating structure 122 may be a resilient tongue, and the like. Furthermore, instead of providing mating structures respectively on the shield housing 120 and the terminal module 110 for mating, the terminal module 110 may be removably secured within the accommodating cavity 121 in other ways, such as bonding to each other by a non-permanent adhesive, fastening to each other by bolts or pins, and the like.

The plastic housing 130 may define a matching channel 131. The shielding housing 120 may be removably secured within the matching channel 131. As a non-limiting example, a third mating structure 123 may be formed on the outer wall of the shielding housing 120, and a fourth mating structure 132 for mating with the third mating structure 123 may be formed on the inner wall of the plastic housing 130. With the mating between the third mating structure 123 and the fourth mating structure 132, the shielding housing 120 may be removably secured in place within the matching channel 131 in a fixed orientation, so as to subsequently match with other electrical connectors (not shown). As an example, it is shown in FIGS. 3 and 4 that, the third mating structure 123 may be a barb-shaped tab and the fourth mating structure 132 may be a groove, both of which may be secured to each other by an interference fit. However, without limitation, the second mating structure 122 and the fourth mating structure 132 may be mating structures of any type, for example, the third mating structure 123 may be a groove and the fourth mating structure 132 may be a tab or a beam, the third mating structure 123 may be a pin and the fourth mating structure 132 may be a socket, the third mating structure 123 may be a groove and the fourth mating structure 132 may be a resilient tongue, and the like. Furthermore, in addition to providing mating structures respectively on the plastic housing 130, the shield housing 120 for mating, the shield housing 120 may be removably secured within the matching channel 131 in other ways, such as bonding to each other by a non-permanent adhesive, fastening to each other by bolts or pins, and the like.

The plastic housing 130 may be formed by various molding methods (including, but not limited to, molded plastic molding, 3D printing molding and the like). The plastic housing 130 may be made of various insulating materials. The material of plastic housing 130 may be different from the material of insulator 112. The plastic housing 130 may be made of insulating materials that are less expensive, including, but not limited to general plastic materials that meet in-vehicle specifications, PA66 for example.

As mentioned above, the material of insulator 112 can be selected to be a material meeting the requirement of high frequency transmission, such as LCP material. The cost of LCP material is usually higher than the material of plastic housing 130, however, the split structure of this application can reasonably control the amount of LCP material in the electrical connector and meanwhile meet the high frequency performance requirement of high-speed electrical connector.

As a non-limiting example, the high-speed electrical connector 100 may serve as a board-end electrical connector. For example, the high-speed electrical connector 100 may serve as an H-MTD connector, HSD connector, HFM connector, MTD connector and the like, for board-end connections of a printed circuit board.

The terminal module 110 and the shielding housing 120 can form a terminal assembly. The electrical connector shown in FIGS. 2-6 has a single terminal assembly consisting of a single terminal module 110 and a single shielding housing 120, thus it can be referred to as a single-channel electrical connector, however, it is to be understood that, the design of the present disclosure may also be applicable to other electrical connector with multiple channels (in that case multiple terminal assemblies are mounted within a single plastic housing 130).

As a non-limiting experimental result, when the terminal assembly consisting of terminal module 110 and shielding housing 120 is a STP terminal assembly (which means the terminal module has two conductive terminals 111 to be connected with ends of shielded twisted pair (STP)), and the plastic housing 130 of FIGS. 2-6 is made of PA66 thermoplastic materials, with a relative permittivity of 3.5, and the material of the insulator 112 has a relative permittivity lower than that of the PA66 thermoplastic materials, for example between 2.7 and 3.3, it has been verified that an intended high frequency performance can be achieved in this STP electrical connector.

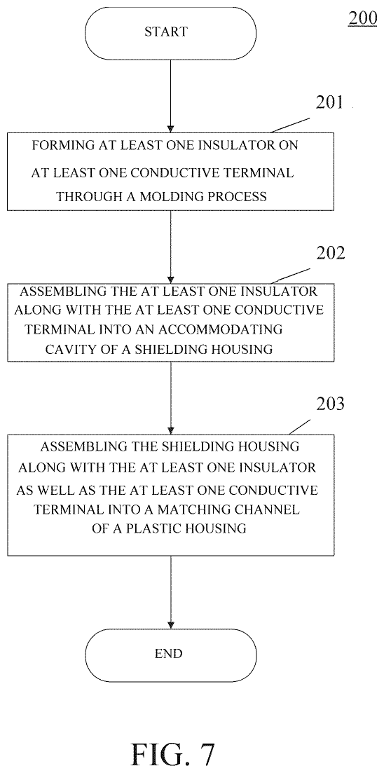

As a comparison, for an electrical connector of an STP terminal assembly, when material of the insulator is LCP with relative permittivity of 3.0, its differential impedance can be higher than one-piece housing with relative permittivity of 3.5, for 5 dB. A method 200 according to an embodiment is described below with respect to FIG. 7. The method 200 may be used to manufacturing a high-speed electrical connector, such as the high-speed electrical connector 100 described above.

The method may start with step 201. At step 201, at least one insulator 112 may be formed on at least one conductive terminal 111 through a molding process. The insulator 112 may wrap around the conductive terminal 111. The molding process includes, but not limited to, insert molding, immersion molding, spray molding, deposition molding and the like, or the combination thereof.

At step 202, the insulator 112 along with the conductive terminal 111 may be assembled into the accommodating cavity 121 of the shielding housing 120, to form a terminal assembly.

At step 203, the shielding housing 120 along with the insulator 112 as well as the conductive terminal 111 may be assembled into the matching channel 131 of the plastic housing 130. The material of insulator 112 may be different from that of the plastic housing 130. Such as, the material of insulator 112 may be an LCP material, which may have a relative permittivity lower than the material of plastic housing 130.

With the high-speed electrical connector 100 and the method 200 of the present disclosure, at least the following beneficial technical effects can be achieved:
By a more reasonable selection of materials for the insulator 112, as well as a disaggregated design wherein the insulator 112 is separated from the plastic housing 130, it is possible to achieve an effective transmission of Ethernet signal at a higher speed e.g., 10 gigabits per second (Gbps) or more under harsh working conditions, so as to obtain a higher reliability for the high-speed electrical connector 100.
Moreover, the high-speed electrical connector 100 takes advantages of the disaggregated design wherein the insulator 112 is separated from the plastic housing 130, which allows for using different materials to achieve a high transmission rate while reducing the cost of the high-speed electrical connector 100.

It is appreciated that in other scenario, when a higher-cost material with a relative permittivity higher than that of plastic housing is intended to be used, this higher-cost material can also be used in the above said split structure to form insulator 112, so as to reduce the entire manufacturing cost.

In some aspects, the techniques described herein relate to an electrical connector, including: a terminal assembly consisting of a terminal module and a shielding housing, the terminal module including at least one conductive terminal and at least one insulator, wherein the at least one insulator is molded on the at least one conductive terminal and wraps around the at least one conductive terminal, wherein the shielding housing defines an accommodating cavity, wherein the terminal module is removably secured within the accommodating cavity; and a plastic housing defining a matching channel, wherein the shielding housing is removably secured within the matching channel and wherein a first material of the at least one insulator is different from a second material of the plastic housing.

In some aspects, the techniques described herein relate to an electrical connector, wherein the first material of the insulator has a relative permittivity different from the second material of the plastic housing.

In some aspects, the techniques described herein relate to an electrical connector, wherein the plastic housing is made of polyamide 66 (PA66) thermoplastic materials, and the first material of the insulator has a relative permittivity lower than that of the PA66 thermoplastic materials.

In some aspects, the techniques described herein relate to an electrical connector, wherein the first material of the insulator is a liquid crystal polymer (LCP).

In some aspects, the techniques described herein relate to an electrical connector, wherein the insulator has a relative permittivity between 2.7 and 3.3.

In some aspects, the techniques described herein relate to an electrical connector, wherein the relative permittivity of the insulator is about 3.0.

In some aspects, the techniques described herein relate to an electrical connector, wherein the terminal assembly is an STP terminal assembly configured to be connected with a shielded twisted pair (STP) cable.

In some aspects, the techniques described herein relate to an electrical connector, wherein the at least one insulator includes: a first insulator, the first insulator being positioned in a middle of the at least one conductive terminal: and a second insulator, the second insulator being positioned near an end of the at least one conductive terminal.

In some aspects, the techniques described herein relate to an electrical connector, wherein the at least one conductive terminal is a signal terminal for transmitting data signal.

In some aspects, the techniques described herein relate to an electrical connector, wherein the insulator is molded on the at least one conductive terminal through an insert molding process.

In some aspects, the techniques described herein relate to an electrical connector, wherein a first mating structure is formed on the insulator, and a second mating structure is formed on an inner wall of the shielding housing for mating with the first mating structure.

In some aspects, the techniques described herein relate to an electrical connector, wherein a third mating structure is formed on an outer wall of the shielding housing, and a fourth mating structure is formed on an inner wall of the plastic housing for mating with the third mating structure.

In some aspects, the techniques described herein relate to an electrical connector, wherein the electrical connector is a board-end connector.

In some aspects, the techniques described herein relate to a method for manufacturing an electrical connector, including: forming at least one insulator on at least one conductive terminal through a molding process, wherein the at least one insulator wraps around the at least one conductive terminal: assembling the at least one insulator along with the at least one conductive terminal into an accommodating cavity of a shielding housing to form a terminal assembly: and assembling the shielding housing along with the at least one insulator as well as the at least one conductive terminal into a matching channel of a plastic housing, wherein a first material of the at least one insulator is different from a second material of the plastic housing.

In some aspects, the techniques described herein relate to a method, wherein the first material of the insulator has a relative permittivity different from the material of the plastic housing.

In some aspects, the techniques described herein relate to a method, wherein the plastic housing is made of polyamide 66 (PA66) thermoplastic materials, and the first material of the insulator has a relative permittivity lower than that of PA66 thermoplastic materials.

In some aspects, the techniques described herein relate to a method, wherein the first material of the insulator is a liquid crystal polymer (LCP).

In some aspects, the techniques described herein relate to a method, wherein the insulator has a relative permittivity between 2.7 and 3.3.

In some aspects, the techniques described herein relate to a method, wherein the relative permittivity of the insulator is about 3.0.

In some aspects, the techniques described herein relate to a method, wherein the terminal assembly is an STP terminal assembly configured to be connected with a shielded twisted pair (STP) cable.

Optional embodiments of the disclosure are described above in the detailed description. Nevertheless, it is to be understood that various embodiments and variations may be employed without departing from the wide spirit and range of the disclosure. In accordance with the concept of the disclosure, numerous modifications and variations can be made by those of ordinary skill in the art without creative labor. As a non-limiting example, those skilled in the art may omit one or more of the various portions of the system or structure described above or add one or more portions to the system or structure described above or replace some or all of the various structures or systems involved in the embodiment with other portions having the same or similar functions. Therefore, any technical solution that can be obtained by logical analysis, reasoning, or limited experimentation by those skilled in the art on the basis of the prior art in accordance with the concept of the disclosure shall fall within the scope of protection determined from the claims of the disclosure.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising.” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting.” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electrical connector, comprising:
a terminal assembly consisting of a terminal module and a shielding housing, the terminal module comprising at least one conductive terminal and at least one insulator, wherein the at least one insulator is molded on the at least one conductive terminal and wraps around the at least one conductive terminal, wherein the shielding housing defines an accommodating cavity, wherein the terminal module is removably secured within the accommodating cavity; and
a plastic housing defining a matching channel, wherein the shielding housing is removably secured within the matching channel and wherein a first material of the at least one insulator is different from a second material of the plastic housing.

2. The electrical connector of claim 1, wherein the first material of the insulator has a relative permittivity different from the second material of the plastic housing.

3. The electrical connector of claim 1, wherein the plastic housing is made of polyamide 66 (PA66) thermoplastic materials, and the first material of the insulator has a relative permittivity lower than that of the PA66 thermoplastic materials.

4. The electrical connector of claim 1, wherein the first material of the insulator is a liquid crystal polymer (LCP).

5. The electrical connector of claim 3, wherein the insulator has a relative permittivity between 2.7 and 3.3.

6. The electrical connector of claim 3, wherein the relative permittivity of the insulator is about 3.0.

7. The electrical connector of claim 1, wherein the terminal assembly is an STP terminal assembly configured to be connected with a shielded twisted pair (STP) cable.

8. The electrical connector of claim 1, wherein the at least one insulator comprises:
a first insulator, the first insulator being positioned in a middle of the at least one conductive terminal; and
a second insulator, the second insulator being positioned near an end of the at least one conductive terminal.

9. The electrical connector of claim 1, wherein the at least one conductive terminal is a signal terminal for transmitting data signal.

10. The electrical connector of claim 1, wherein the insulator is molded on the at least one conductive terminal through an insert molding process.

11. The electrical connector of claim 1, wherein a first mating structure is formed on the insulator, and a second mating structure is formed on an inner wall of the shielding housing for mating with the first mating structure.

12. The electrical connector of claim 1, wherein a third mating structure is formed on an outer wall of the shielding housing, and a fourth mating structure is formed on an inner wall of the plastic housing for mating with the third mating structure.

13. The electrical connector of claim 1, wherein the electrical connector is a board-end connector.

14. A method for manufacturing an electrical connector, comprising:
forming at least one insulator on at least one conductive terminal through a molding process, wherein the at least one insulator wraps around the at least one conductive terminal;
assembling the at least one insulator along with the at least one conductive terminal into an accommodating cavity of a shielding housing to form a terminal assembly; and
assembling the shielding housing along with the at least one insulator as well as the at least one conductive terminal into a matching channel of a plastic housing, wherein a first material of the at least one insulator is different from a second material of the plastic housing.

15. The method of claim 14, wherein the first material of the insulator has a relative permittivity different from the material of the plastic housing.

16. The method of claim 14, wherein the plastic housing is made of polyamide 66 (PA66) thermoplastic materials, and the first material of the insulator has a relative permittivity lower than that of PA66 thermoplastic materials.

17. The method of claim 14, wherein the first material of the insulator is a liquid crystal polymer (LCP).

18. The method of claim 16, wherein the insulator has a relative permittivity between 2.7 and 3.3.

19. The method of claim 16, wherein the relative permittivity of the insulator is about 3.0.

20. The method of claim 16, wherein the terminal assembly is an STP terminal assembly configured to be connected with a shielded twisted pair (STP) cable.
